(19) United States
(12) Patent Application Publication
(10) Pub. No.: US 2007/0132610 A1
(43) Pub. Date: Jun. 14, 2007

(54) Mounting of a rearview camera in a protection housing with a view window

(76) Inventors: Stevan Guernalec, Auffargis (FR); Marcel Trebouet, Nom La Bretche (FR); Franck Cathala, St. Martin Laguepie (FR)

Correspondence Address: OSHA LIANG L.L.P., 1221 MCKINNEY STREET, SUITE 2800, HOUSTON, TX, 77010, US

(21) Appl. No.: 10/576,597

(22) PCT Filed: Oct. 25, 2004
(86) PCT No.: PCT/EP04/12030

§ 371 Date: Apr. 21, 2006

(30) Foreign Application Priority Data
Oct. 23, 2003 (FR) 0312425

(51) Int. Cl. G08G 1/14; H04N 7/18

(52) U.S. Cl. 340/932.2; 348/148

(57) ABSTRACT

The invention provides an arrangement for mounting and fixing a rearview camera (10) on a body shell structure element of a motor vehicle, said camera (10) being arranged at the back of the vehicle with the optical axis (C) thereof globally oriented longitudinally towards the rear. Said invention is characterised in that the camera is arranged inside a hermetically-sealed housing (12), comprising a view window which is located in the optical axis (C) of the camera (10).

The invention relates to an arrangement for mounting a rearview camera on a structure element of the body of a motor vehicle, said arrangement including means for protecting the lens of the camera.

The invention relates more particularly to an arrangement for mounting and fixing a rearview camera to a structure element of the body of a motor vehicle, the arrangement being of the type in which the camera is arranged at the rear of the vehicle and its optical axis extends substantially longitudinally towards the rear, the camera being arranged inside a hermetically-sealed housing that is provided with a view window situated on the optical axis of the camera.

Rearview cameras equip a large number of present-day motor vehicles, and such a camera is part of a parking assistance system that makes it possible to detect obstacles situated behind the vehicle.

Such a camera is generally arranged at the rear bumper or at the rear license plate of the vehicle. The camera is thus highly exposed to impacts and to being splashed with pollutants that can be deposited on its lens, thereby reducing its effectiveness.

It is known that a cleaning device, generally a cleaning liquid spray nozzle, for cleaning the lens of the camera can be arranged in the vicinity of the camera lens for the purpose of removing any pollutants that have been deposited on it.

However, the lens of the camera is a relatively fragile element and it is not protected from thrown-up stones, grit, or other particles that might damage it.

It is also known that the camera can be mounted inside the exterior trim of the vehicle, and that it can be protected from attack from the outside environment by means of a protective pane fixed to the trim. Although the camera is protected from attack from the outside environment, the camera remains subjected to deposition of pollutants that are to be found inside the vehicle, and it is particularly difficult to clean the camera in such an arrangement.

An object of the invention is to provide an arrangement for fixing the camera that makes it possible, in addition, to protect the camera, and more particularly the lens of the camera, and that also makes it possible to clean off sprayed or splashed pollutants.

To this end, the invention provides an arrangement for mounting and fixing a rearview camera to a structure element of the body of a motor vehicle, the arrangement being of the type in which the camera is arranged at the rear of the vehicle and its optical axis extends substantially longitudinally towards the rear;

the camera being arranged inside a hermetically-sealed housing that is provided with a view window situated on the optical axis of the camera; said arrangement being characterized in that the window is constituted by an opening in the housing that is provided on the optical axis of the camera and that is closed off by a transverse vertical pane made of a transparent material.

According to other characteristics of the invention:

the housing includes a frame for supporting the pane which defines a rear transverse vertical wall, and the pane is pressed longitudinally towards the rear against a front transverse vertical face of the frame;

the frame carries resilient elements which are in contact with the front transverse vertical face of the pane, for holding the pane pressed against the front face of the frame;

the top face of a bottom transverse segment of the frame slopes downwards, from the bottom edge of the pane;

the housing carries spray means for spraying cleaning liquid for cleaning the outside transverse vertical face of the pane;

the spray means are formed integrally with the housing;

the spray means comprise a nozzle that is fixed to a top horizontal wall of the housing;

the inside vertical transverse face of the pane is covered with a layer of material suitable for generating heat;

the resilient elements are made of an electrically conductive material so as to connect the heater material electrically to an electrical current source;

the arrangement is further provided with strips of conductive material that extend longitudinally inside the housing for electrically connecting the resilient elements to a current source;

each of the resilient elements constitutes a rear end segment of a respective one of the strips of conductive material;

the resilient elements are separate elements mounted on the rear ends of the strips of conductive material;

each of the resilient elements is provided with a presser finger for pressing against the front face of the pane, which finger is suitable for sliding inside a tubular element, and is held resiliently in abutment against the front face of the pane;

the front longitudinal end of each of the strips of conductive material extends inside a socket that extends upwards relative to a top wall of the housing, and that is open at its rear end for receiving a complementary connector;

the housing is provided with a frame for supporting the pane, which frame is overmolded around the peripheral edge of the pane;

the frame and the pane are fixed to the housing by fixing means which are suitable for electrically connecting the layer of heater material to a current source;

the fixing means comprise at least one clip arranged at one edge of the pane, and a longitudinal fixing catch that extends longitudinally forwards from the clip and that is suitable for being received in a complementary recess in the housing;

the clip is provided with at least one contact finger for establishing contact with the layer of heater material;

the fixing means are made in one piece by cutting out and folding a strip of electrically conductive material;

the clip is provided with means for vertically positioning it relative to the pane;

the fixing means are symmetrical about a horizontal midplane;

the frame is overmolded around the clip of each fixing means;

the structural vehicle-body element has a rear vertical wall and a bottom horizontal wall which extends longitudinally forwards from the bottom edge of the rear wall, and the body of the housing passes through a complementary orifice in the bottom wall at least in part; it is provided with means for deflecting water flowing over the rear wall, substantially above the camera;

the arrangement is provided with a tongue that extends vertically downwards from the bottom wall, behind the camera, and that has a free bottom end edge that is arched so as to re-direct, at least in part, the water flowing over the rear wall;

the bottom edge of the tongue is curved back towards the rear to form an arched lip;

the rear wall is provided with a projection that projects towards the rear;

the housing is made of a transparent material, and each of its walls other than the rear vertical transverse wall is covered with a layer of an opaque material;

the pane is in the form of a disk that is coaxial with the optical axis C of the camera, and the peripheral edge of the pane is provided with a thread that co-operates with a complementary thread in the frame so as to seal the opening in the housing hermetically and in removable manner;

the arrangement includes:

at least one resilient electrical connection means; and

conductive tracks provided in the housing and designed for electrically powering the layer of material suitable for generating heat;

the resilient connection means being placed such as to generate electrical contact between said layer and said tracks;

one resilient connection means extends over a first side of the rear face of the pane and another resilient connection means extends over a second side of the face opposite from the first face;

the arrangement is provided with sealing means whose rear portion is overmolded around the peripheral edge of the resilient connection means and extends over the periphery of the rear face of the pane;

the sealing means are in the form of a non-conductive elastomer;

the sealing means further include a front portion connected to the rear portion via at least one bridge, the bridge being designed to be folded so that the rear portion and the front portion are placed respectively against the rear transverse face and against the front transverse face of the pane;

the arrangement is provided with a thermal protection component for regulating the temperature of the layer;

the thermal protection component is electrically coupled between the resilient connection means and the conductive tracks;

the resilient connection means are filled with electrically conductive particles; and

the arrangement is provided with a locking clip suitable for compressing the resilient connection means between the pane and the conductive tracks.

Other characteristics and advantages of the invention will appear on reading the following detailed description which, to make it easier to understand, is given with reference to the accompanying figures, in which:

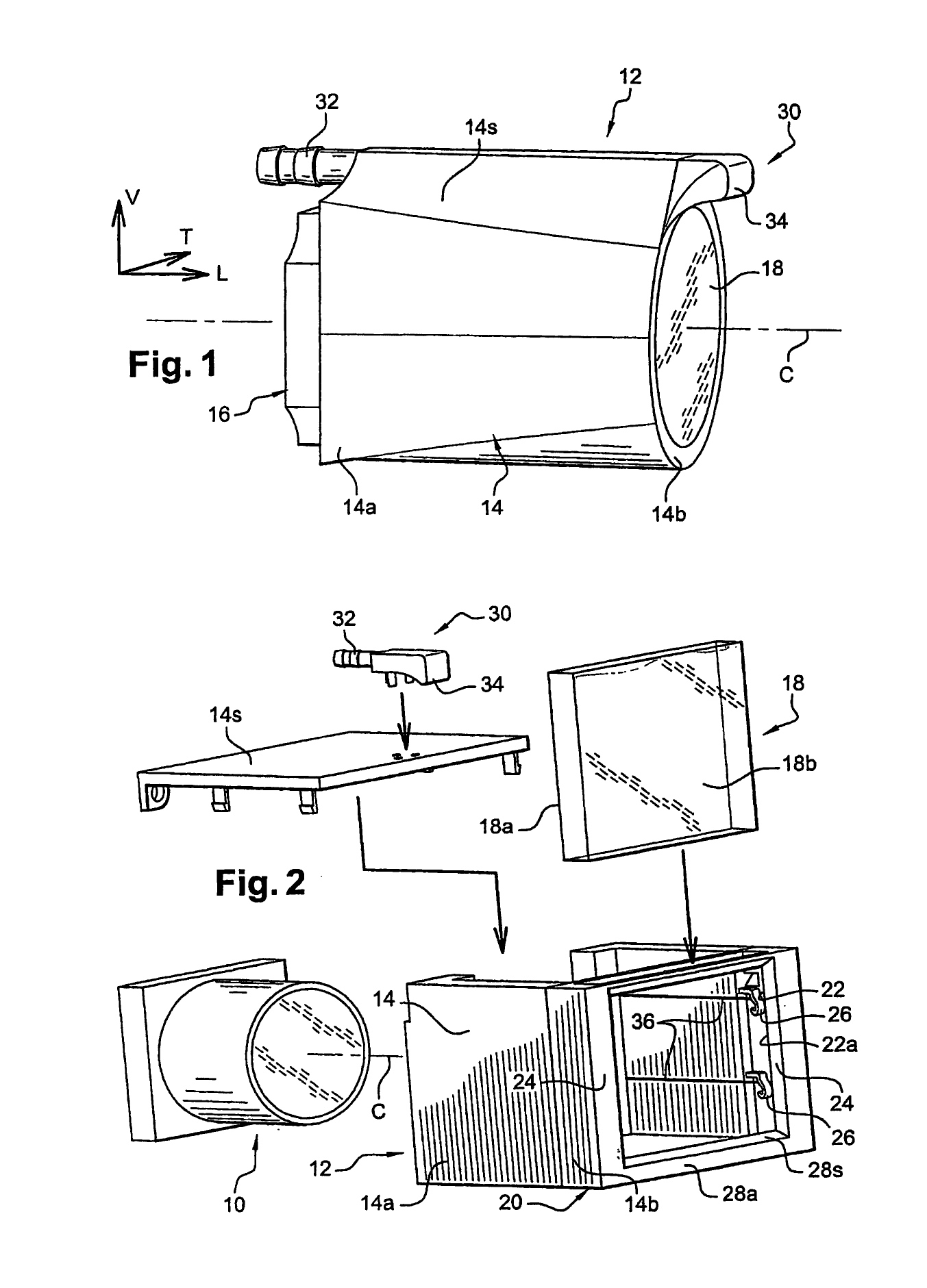

FIG. 1 is a diagrammatic perspective view of an arrangement of the invention for mounting a camera;

FIG. 2 is an exploded view of another embodiment of the arrangement of the invention;

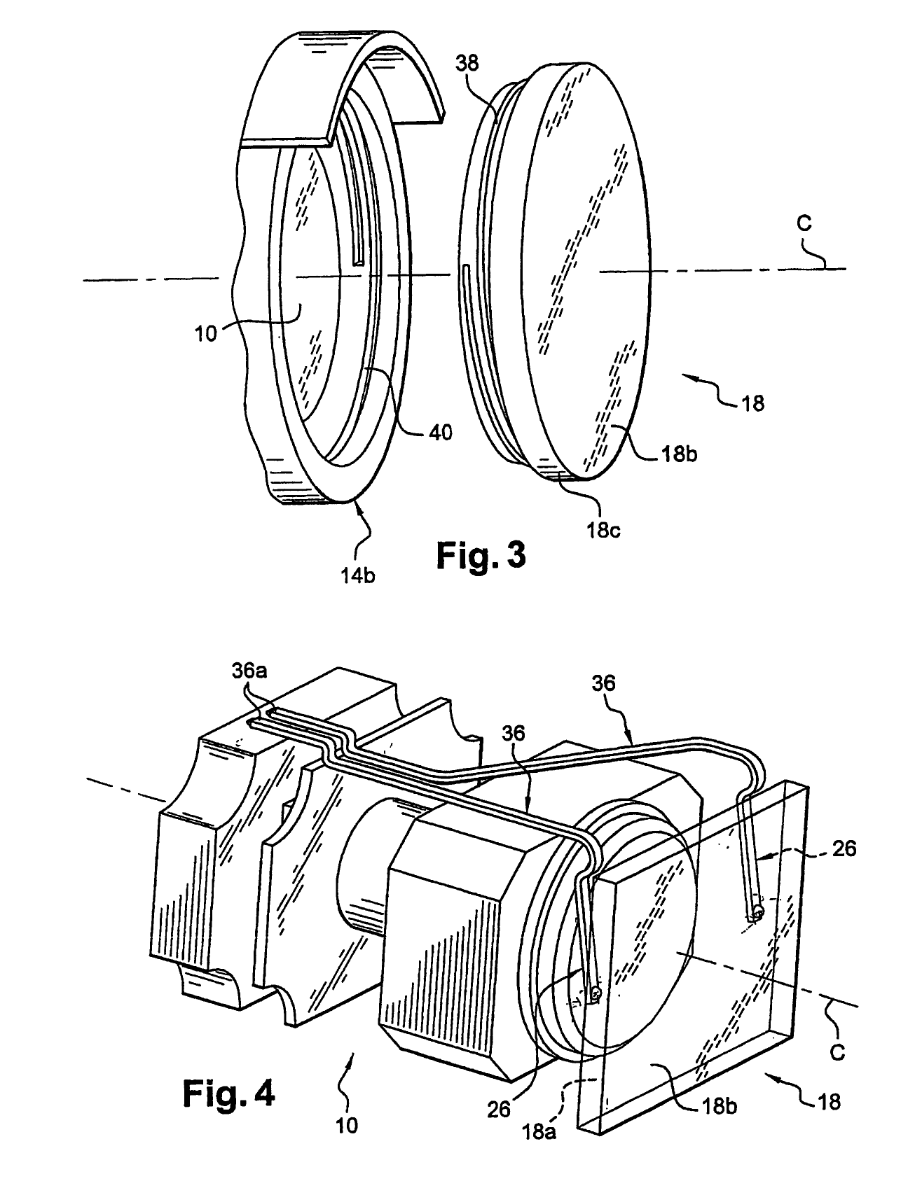

FIG. 3 is a detail on a larger scale of the mounting of the pane on the body of the housing shown in FIG. 1;

FIG. 4 is a diagrammatic view of the camera, of the pane and of the means for electrically connecting the layer of heater material to the current source;

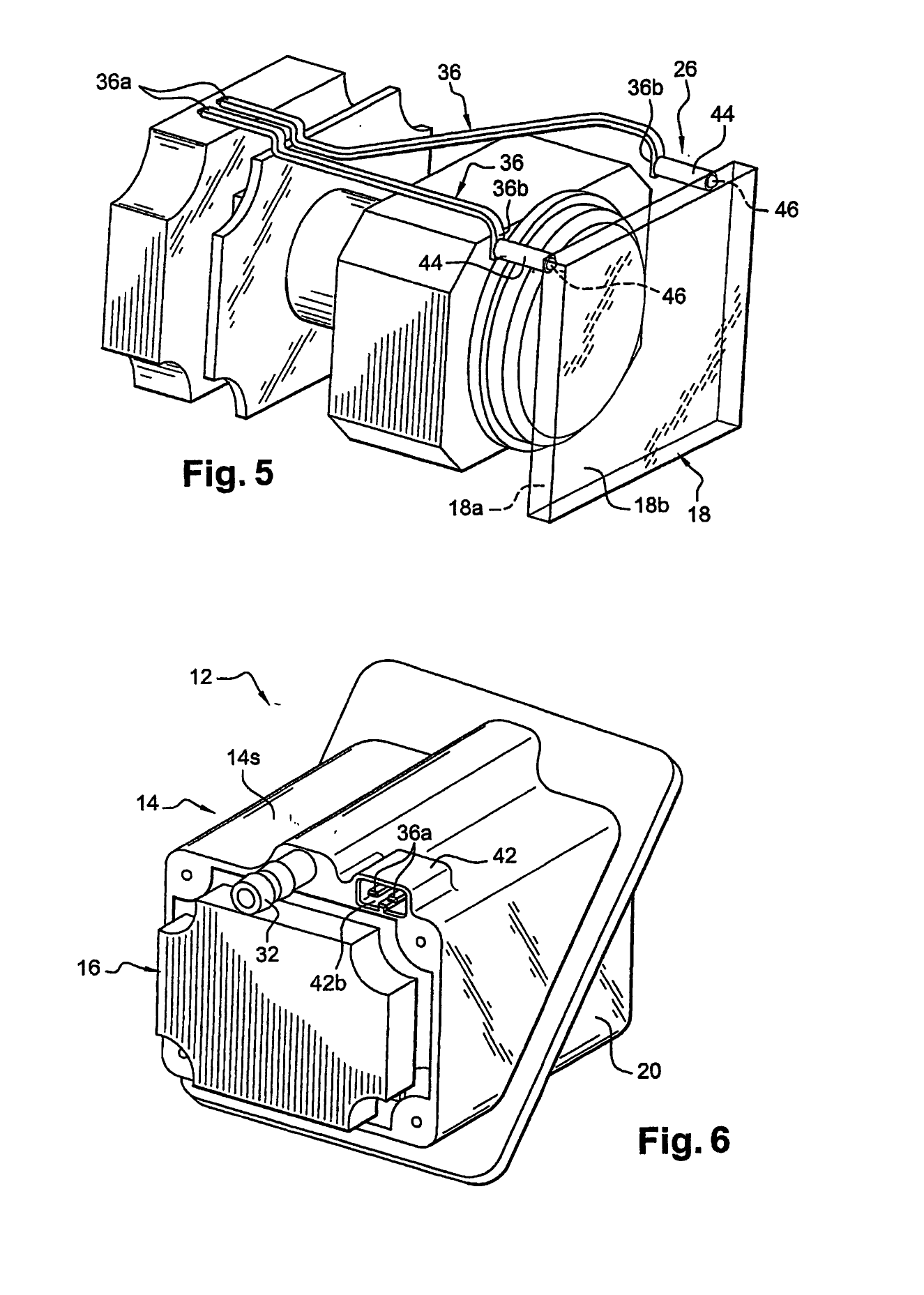

FIG. 5 is a view similar to the view of FIG. 4, showing a variant embodiment of the resilient elements;

FIG. 6 is a perspective view looking towards the rear, showing the arrangement of the invention and showing the female connector formed by the strips of conductive material and by the associated socket;

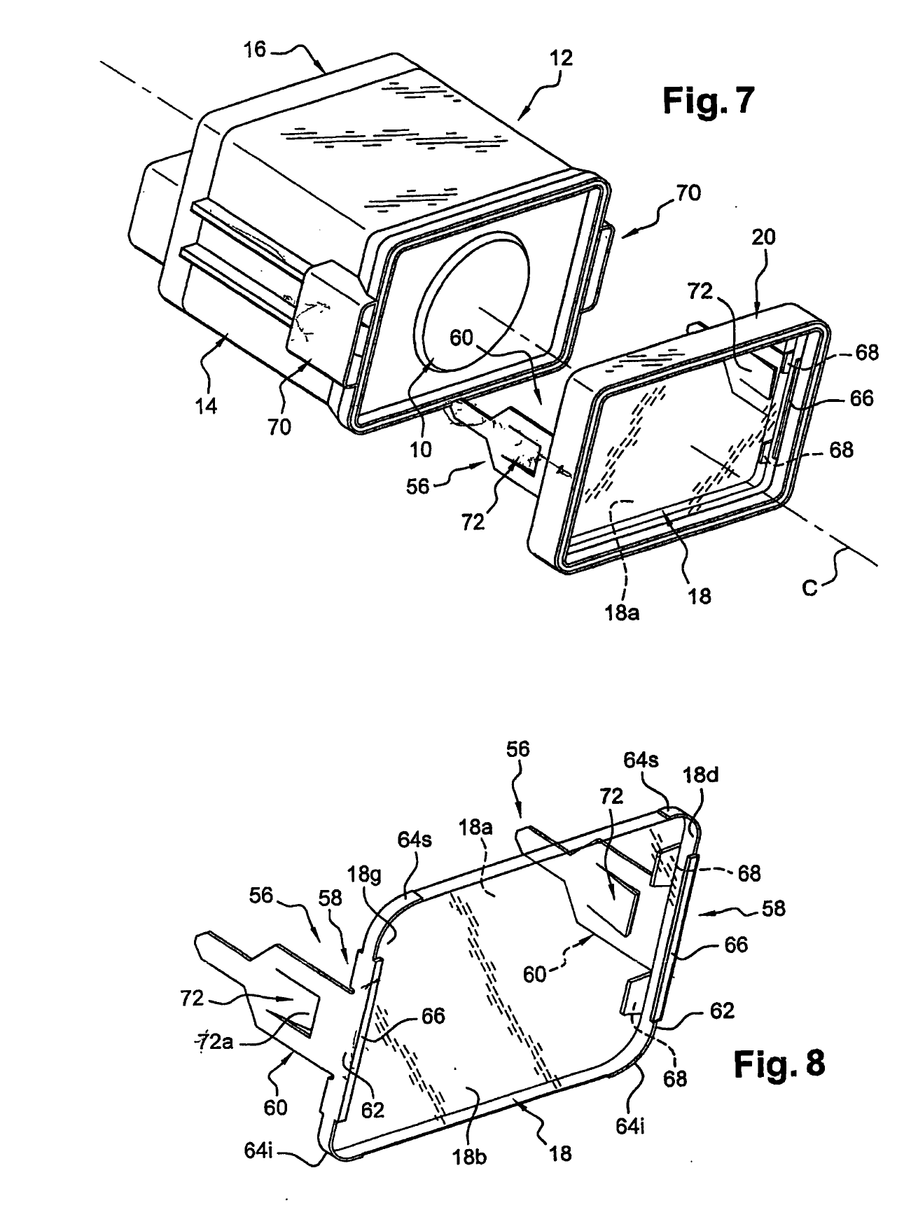

FIG. 7 is a view similar to the FIG. 2 view, showing another mode of fixing the frame by electrical connection means;

FIG. 8 is a detail on a larger scale of the pane and of the electrical connection means shown in FIG. 7;

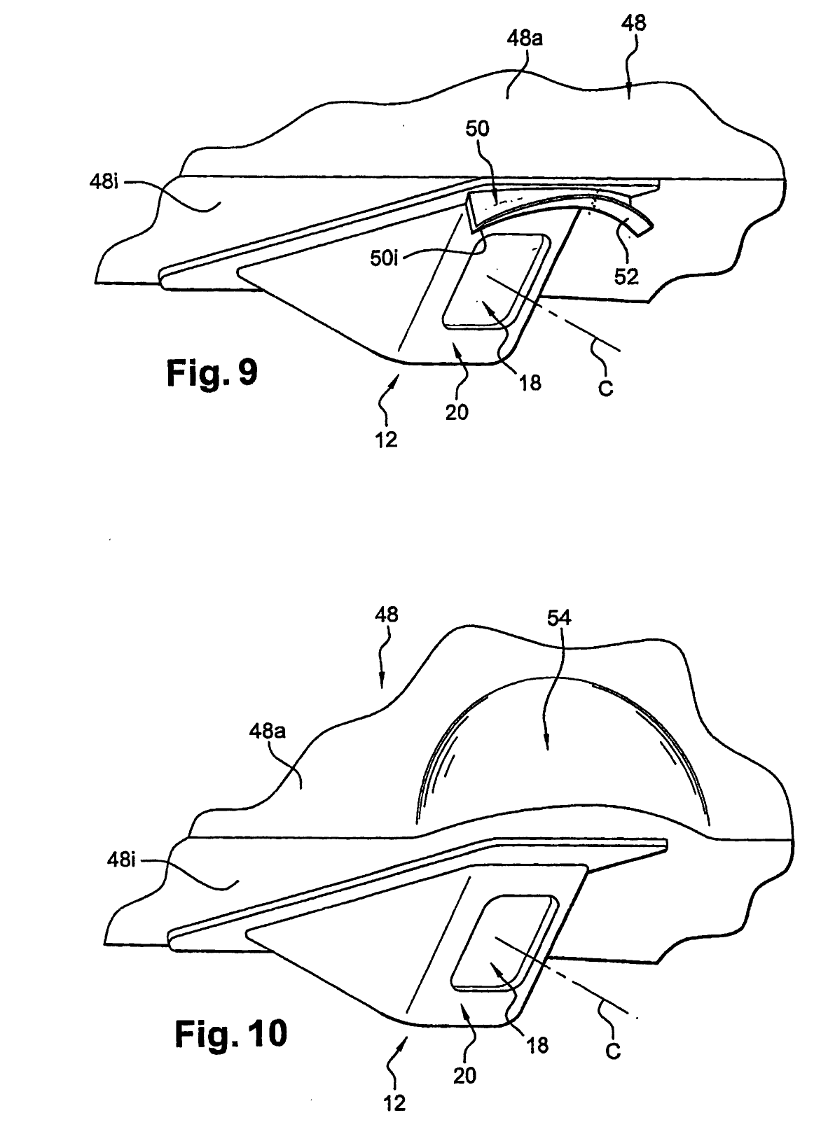

FIG. 9 is a view similar to the view of FIG. 1, and in which the housing and the camera are in the position in which they are mounted on an equipment module of the vehicle, showing the means for deflecting water running over the rear face of the equipment module;

FIG. 10 is a view similar to the view of FIG. 9, showing another embodiment of the water deflector means;

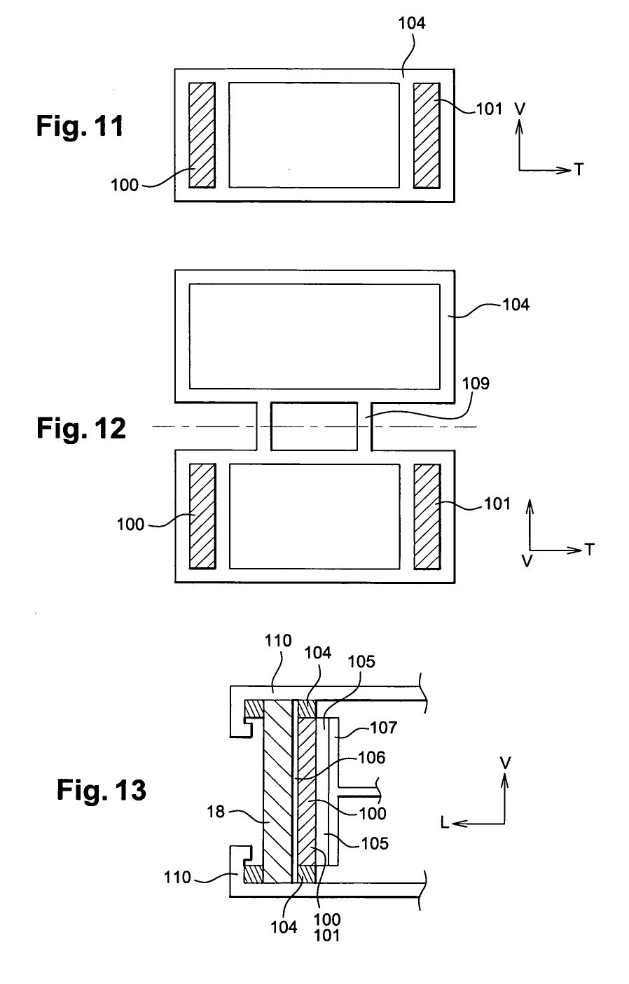

FIG. 11 is a view of sealing means for sealing the housing of the camera hermetically, which means are overmolded onto two electrically conductive elastomer pads;

FIG. 12 is a view of another embodiment of the housing of the camera, which housing is designed to cover the front side and the rear side of a pane; and

FIG. 13 is a sectional view of a front portion of an arrangement of the invention, in which the sealing means of FIG. 12 are mounted.

For the description of the invention, and by way of non-limiting example, let the vertical, longitudinal, and transverse directions be as shown in the reference frame V, L, T indicated in the figures.

Let the forward direction be the longitudinal direction from right to left with reference to FIG. 1.

In the following description like reference numerals are used to designate elements that are identical, similar or analogous.

FIGS. 1 and 2 show an arrangement for mounting a rearview camera 10 that is part of a parking assistance device of a motor vehicle.

The camera 10 is thus mounted on the rear of the vehicle, generally in the vicinity of the rear bumper or of the rear license plate (neither of which is shown), and its optical axis C extends towards the rear and downwards, so that the camera can detect low obstacles that are situated behind the vehicle and that cannot be seen by the driver.

The camera 10 is received inside a protection housing 12 which firstly fixes the camera 10 to the body of the vehicle and which secondly protects the body of the camera 10.

The housing 12 comprises a substantially cylindrical body 14 whose axis coincides with the optical axis C of the camera 10, the body being open at its front end 14a so that the camera 10 can be inserted into the internal volume of the housing 12, and being open at its rear end 14b along the optical axis C of the camera 10 so as to make outward viewing possible.

In the invention, in order to protect the camera 10, the housing 12 is hermetically-sealed.

To this end, the housing 12 has a front cover 16 which hermetically seals the opening in the front end 14a of the body 14, and the opening in the rear end 14b of the body 14 of the housing 12 is hermetically-sealed by a pane 18.

The front cover 16 is provided with an orifice (not shown) for passing the cables necessary to operation of the camera 10.

In a variant (not shown), the front cover 16 is provided with an orifice which is closed off by a membrane made of a material suitable for passing air but not water. The membrane can thus be termed a breather membrane making it possible in particular to balance the pressure inside the housing 12 in the event that the temperature varies.

The pane 18 is situated in the optical axis C of the camera 10, and it extends in a plane that is substantially vertical and transverse. It is made of a transparent material so as not to adversely affect the effectiveness of the camera 10. Thus, for example, the pane 18 is made of glass or of a transparent plastics material such as polycarbonate.

It is thus the pane 18 that is subjected to all of the attacks from the outside environment, i.e. both spraying up or splashing of pollutants and stones, grit, or chippings, and also deposits of pollutants.

The pane 18 is made of a material which is less fragile than the lens of the camera 10. In addition, it is easier and less costly to replace a pane 18 of the invention, if the original pane becomes badly damaged, than to replace the lens of the camera 10.

In addition, the pane 18 of the invention can be cleaned by conventional means, without needing special care to be taken in cleaning.

In a first embodiment of the invention, the pane 18 is carried by a frame 20 which hermetically seals the opening in the rear end 14b of the body 14.

The frame 20 is provided with two vertical grooves 22, formed in the facing inside vertical longitudinal walls of the uprights 24 of the frame 20, and the grooves are open at their top ends for the purpose of receiving the pane 18 which is inserted by a downward vertical movement.

In order to make the coupling between the housing 12 and the pane 18 hermetic, the pane 18 is pressed against the front-facing vertical transverse faces 22a of the grooves 22 and of the frame 20. Tightness can, in addition, be supplemented by a seal (not shown).

In order to press the pane 18 in longitudinal abutment against the front-facing transverse vertical faces 22a of the grooves 22 and of the frame 20, the frame 20 carries resilient element 26 that are, in this example, hook-shaped, and that exert on the front transverse vertical face 18a of the pane 18 a pressing force that presses the pane 18 towards the rear.

For locking the pane 18 to prevent it from moving vertically upwards relative to the frame 20, as can be seen in FIG. 2, the top horizontal wall 14s of the body 14 is a separate element mounted on the body 14 that is fixed to the other portion of the body 14 after the pane 18 has been mounted in the frame 20, in a manner such as to cover the top edge of the pane 18, thereby preventing it from moving vertically upwards.

In a variant embodiment of the invention, the frame 20 is overmolded around the pane 18, and, in another variant embodiment of the invention, the pane 18 is directly bonded with adhesive to the rear end 14b of the body 14.

As can be seen in FIG. 2, the rear transverse vertical face 28a of the bottom segment 28 of the frame 20 is situated longitudinally to the rear of the rear face 18b of the pane 18.

In another aspect of the invention, the top face 28s of the bottom segment 28 of the frame 20 slopes downwards, from the bottom edge of the pane 18 to the top edge of the rear face 28a of the bottom segment 28, in order to avoid pollutants building up at the bottom edge of the pane 18, and in order to enable pollutants to be removed by runoff.

The outside face 18b of the pane 18 is cleaned by means of a cleaning liquid spray device 30 that is arranged at the top wall 14s of the body 14.

In a first embodiment of the spray device 30, as shown in FIG. 1, said device is formed integrally with the body 14, and it has a coupling end-piece 32 for coupling with a cleaning liquid dispenser device (not shown) and a nozzle 34 that sprays the cleaning liquid onto the outside face 18b of the pane 18.

FIG. 2 shows another embodiment of the spray device 30 which constitutes a separate element that is fixed to the top wall 14s of the housing 14 by any known means, such as, for example, by adhesive bonding or by some other type of bonding, such as welding or heat-sealing.

Among the elements that can adversely affect the effectiveness of the camera 10, mention is made of frost, ice, and mist that can be deposited on the rear face 18b of the pane 18. In order to remove these types of pollutants, it is known that the pane 18 can be heated to cause the water present on the pane 18 to evaporate.

For this purpose, and in another aspect of the invention, the inside vertical transverse face 18a of the pane 18 is covered, fully or partially, with a layer of a material suitable for generating heat when an electrical current flows through it, this layer being referred to below as the “layer of thermal material”.

In an advantageous embodiment of the invention, the layer of thermal material is electrically powered via the resilient elements 26 which are made of an electrically conductive material.

For this purpose, the resilient elements 26 are electrically connected to an electrical current source via strips of conductive material 36 that extend longitudinally forwards along a side vertical wall of the body 14, and in this example the left side wall 14g.

In a preferred embodiment of these current feed means, the strips 36 are formed integrally with the resilient elements 26, and they consist of longitudinal metal rods whose rear ends are shaped so as to form the resilient elements 26.

FIG. 3 shows another embodiment of the housing 12 in which the pane 18 is suitable for being removed.

To this end, the pane is in the form of a disk coaxial with the optical axis C of the camera 10, and its peripheral circular edge 18c is provided with a thread 38 that co-operates with a complementary thread 40 in the body 14 for the purpose of fixing the pane 18 to the body 14, or for the purpose of removing the pane 18 from the body 14.

In addition, the fact that the pane 18 is removable makes it possible to replace it with a new pane, when it becomes too badly damaged to enable the camera 10 to operate properly.

In a variant embodiment (not shown) of how the pane 18 is assembled removably to the housing 12, the pane 18 is secured to the frame 20, and it is the frame 20 which is in the form of a disk whose peripheral edge is provided with a thread which co-operates with a complementary thread in the rear end 14b of the body 14.

FIGS. 4 to 6 show two variant embodiments of the strips of conductive material 36 and of the resilient elements 26, in which variant embodiments resilient elements 26 are distributed symmetrically about a vertical longitudinal midplane of the pane 18, in the vicinity of the side vertical edges of the pane 18.

In addition, in these variant embodiments, strips of conductive material 36 extend above the camera 10, along the top wall 14s of the body 14, and, as can be seen in FIG. 5, the front longitudinal ends 36a of the two strips of conductive material 36 extend inside a socket 42 which projects upwards from the top face of the top wall 14s, and which is open over its rear end 42b.

The strips of conductive material 36 and the socket 42 thus form a female connector which receives a complementary male connector (not shown) for electrically connecting the resilient elements 26 to the electrical current source.

In the first variant embodiment shown in FIG. 4, each of the resilient elements 26 is constituted by a rear end segment of a respective one of the strips of conductive material 36, and extends substantially vertically downwards and towards the rear, so that its free rear bottom end 26i is in contact with the front face 18a of the pane 18, at a place situated vertically substantially in the middle of the pane 18.

In the second variant embodiment shown in FIG. 5, the resilient elements 26 are separate elements that are fixed to the rear ends 36b of the strips of conductive material 36.

In this variant, each of the resilient elements 26 comprises a substantially tubular element 44 of longitudinal main axis and inside which a finger 46 is suitable for sliding. The finger 46 is urged resiliently towards the rear by a resilient element (not shown) so as to maintain continuous contact with the layer of thermal material.

The tubular element 44, the finger 46 and the resilient element are made of an electrically conductive material.

Due to them extending mainly longitudinally, the resilient elements 26 are compact vertically, which makes it possible to arrange them at the top corners of the pane 18.

As can be seen in FIG. 6, in this example, the top wall 14s of the body 14 is formed integrally with the body 14, the pane 18 is thus mounted on the frame 20 before the frame 20 is fixed to the body 14 so as to close the housing 12 in sealed manner.

FIGS. 7 and 8 show another embodiment of the housing 12, in which the means 56 for fixing the frame 20 and the pane 18 to the body 14 also electrically connect the layer of thermal material to the current source.

As can be seen in more detail in FIG. 8, two fixing means 56 are provided, each of which comprises a clip 58 which is connected to the pane 18 at a respective one of the right and left side end vertical edges 18d, 18g of the pane 18, and a fixing catch 60 which extends longitudinally forwards from the clip 58.

The fixing means 56 are made of an electrically conductive material, and preferably of a material based on iron. In addition, the clip 58 and the associated fixing catch 60 are made in one piece by cutting out and folding a metal strip.

The clip 58 comprises an upright 62 which covers the entire associated side edge 18d, 19g of the pane 18, and from which fingers of the clip extend to position the clip 58 on the pane 18.

Thus, the clip 58 has a top finger 64s and a bottom finger 64i, each of which fingers extends transversely by overlapping onto the associated top or bottom edge of the pane 18, and by extending the free top or bottom end of the upright 62.

The clip further comprises a rear finger 66 that presses against the rear face 18b of the pane 18, and that, in this example, consists of a vertical strip which extends the rear edge of the upright 62 transversely.

Finally, the clip further comprises two front fingers 68 that press against the front face 18a of the pane 18, and that consist, in this example, of transverse strips that extend the front edge of the upright 62.

The front fingers 68 press against the front face 18a of the pane 18, and therefore, they are in contact with the layer of thermal material.

The clip 58 is positioned vertically relative to the pane 18 by the top and bottom fingers 64s, 64i, which makes it possible to position the front fingers 68 relative to the associated contacts (not shown) of the layer of thermal material.

The fixing means 56 are secured to the pane 18 by fixing the frame 20 to the pane 18.

For this purpose, in a preferred embodiment, the frame 20 is formed by being overmolded around the pane 18 so as to cover the peripheral edge of the pane 18 and the clips 58 of the fixing means 56.

This makes it possible, in addition, to guarantee hermetic sealing between the pane 18 and the frame 20.

The assembly made up of the pane 18, of the frame 20, and of the fixing means 56, is fixed via the fixing catches 60, each of which is received in a respective complementary recess 70 in the body 14 of the housing 12.

The fixing catches 60 are vertical longitudinal strips, each of which extends longitudinally forwards from the upright 62 of the associated clip 58.

In order to facilitate inserting the fixing caches 60 into the associated recesses 70, the width of each catch, i.e. its vertical dimension, at its free front longitudinal end 60a is smaller than the width of the remainder of the catch.

Each of the fixing catches 60 is also provided with an elastically deformable finger 72 that is suitable for retracting while the catch 60 is being inserted into the recess, and whose free rear end 72a bears against a transverse face (not shown) of the recess 70, in order to lock the fixing catch 60 longitudinally in the recess 70.

The fixing means 56 are electrically connected to the current source via the fixing catches 60 when said catches are received inside the associated recesses 70, by electrical connection means of a type known per se.

Finally, each fixing means 56 is symmetrical about a horizontal midplane, which makes it possible to have an identical structure for the fixing means 56 arranged on the right and on the left of the pane 18, thereby reducing the costs of making said fixing means 56.

In a variant embodiment, the frame 20 is made of an elastic material such as an elastomer material, so that, when it is mounted on the body 14 of the housing 12, it seals the closure of the housing 12 so as to make it hermetic.

The fixing catches 60 then take part in this sealing by holding the frame 20 pressed against the body 14 so that the frame 20 deforms in part.

The exterior climatic conditions also cause lack of rear visibility.

As shown in FIGS. 9 and 10, the assembly formed by the camera 10 and by the housing 12 is often part of an equipment module 48 that is arranged above the rear license plate (not shown) of the vehicle. The housing 12 then projects downwards relative to a bottom wall 48i of said equipment module 48.

In the event of bad weather, in particular in heavy rain, the water that then runs off the rear vertical wall 48a of the equipment module 48 runs past the camera 10, thereby masking its field of vision in part. The same applies when the weather is very cold, when ice can build up in the form of stalactites on the optical axis of the camera 10.

In order to limit the runoff of water going past the camera 10, means are provided to deflect the flow of water.

FIG. 9 shows a first embodiment of such deflector means which consist of a tongue 50 which extends vertically downwards by extending the bottom edge of the rear vertical wall 48A of the equipment module 48. The bottom edge 50i of the tongue 50 is curved convexly, i.e. it is substantially upside-down U-shaped.

Thus, since the ends of the bottom edge 50i of the tongue 50, i.e. the bottom corners of the tongue 50 are situated lowest relative to the remainder of the tongue 50, the water that runs from the rear wall 48a of the equipment module 48, and that runs along the tongue 50, is redirected towards the bottom corners of the tongue 50, i.e. it is directed away from the optical axis C of the camera 10.

In addition, in order to increase the deflection of the water, the bottom edge 50i of the tongue 50 is curved back towards the rear to form a lip 52 that is arched to match the profile of the bottom edge 50i of the tongue 50. Thus, the water that flows along the tongue 50 is blocked by the top wall of the lip 52 and is thus forced to run off towards the right side or towards the left side of the camera 10.

FIG. 10 shows a second embodiment of the deflector means which consist of a projection 54 which projects towards the rear on the rear wall 48a of the equipment module 48, above the camera 10.

The projection 54 is designed so as to have a profile in relief over a substantially elliptical transverse vertical plane whose width increases going towards the bottom edge of the rear wall 48a.

The projection 54 thus forms an obstacle to the water running down at this location. The water then flows around the projection 54 in order to continue to run down.

In another preferred embodiment of the invention, the body 14 of the housing 12 is made of an opaque material, which makes it possible firstly to conceal the camera 10, and secondly to make it more discreet.

However, in yet another variant embodiment (not shown), the entire housing 12 is made of a transparent material, such as, for example, a polycarbonate, thereby making it possible to simplify fixing the pane 18 to the body 14, because said pane is formed integrally with the body 14.

In order to conceal the camera 10, the side walls of the body 14, i.e. the top and bottom horizontal walls and the right and left vertical longitudinal walls are covered with respective layers of an opaque material, thereby making it impossible to see inside the housing 12.

The above-described arrangement for mounting a rearview camera makes it possible to protect the camera from the various attacks from the outside environment by means of a protection housing that is hermetically-sealed, and that is of relatively simple structure in order to avoid significantly increasing the manufacturing costs.

Finally, in another embodiment of the invention, shown in FIG. 11, the layer of material 106 suitable for generating heat is connected to conductive tracks 107 by electrical connection means 100, 101. The means can be in the form of pads 100, 101 made of an elastomer material, e.g. EPDM, filled with electrically conductive particles, such as carbon or gold. However, any electrically conductive particles can be used. The use of such a pad 100, 101 makes it possible to avoid any risk of attack on the layer 106 of the pane 18.

FIG. 11 shows two pads 100, 101 of elongate shape. The first pad 100 extends over a first side of the rear face 18a of the pane 18, and the second pad 101 extends over a second side of the face 18a that is opposite from the first side of the rear face 18a of the pane 18. The distribution of the current through the layer 106 of the pane 18 is more uniform because the current passes through transversely, thereby taking the shortest path. That is why the elongate shape of the pads 100, 101 makes it possible to obtain fast temperature increases. However, it is also possible to mount the pads on the two opposite transverse sides of the rear face 18a of the pane 18.

As can be seen in FIG. 11, a seal 104 is overmolded around the pads 100, 101 so as to enable waterproof closure to be obtained between the pane 18 and the housing 110. Thus, the overmolded seal makes it possible to insulate the pad 100, 101 of conductive elastomer. The seal 104 is made of a non-conductive elastomer material, e.g. EPDM.

The sealing means 104 can further comprise a front portion connected to the rear portion via at least one bridge 109, the bridge 109 being designed to be folded so that the rear and the front portions are placed respectively against the rear transverse face 18b and against the front face 18a of the pane 18.

The arrangement can further comprise a thermal protection component 105 for regulating the temperature of the layer 106. Pursuant to legislative regulations, the maximum temperature for the outside of a motor car is 60° C. The component 105 makes it possible to limit and to control the heating to no higher than 60° C. To this end, it is installed between the elastomer pad 100, 101 and the conductive tracks 107.

FIG. 13 is a section view showing the pane 18, the layer of material 106 suitable for generating heat, the elastomer pad 100, 101, the thermal protection component 105, and the conductive track 107. FIG. 13 also shows the seal 104 and the housing 110, in which the various layers 18, 100, 101, 105, 106, and 107 are positioned.

The arrangement can further comprise a locking clip (not shown) suitable for compressing the pad between the pane 18 and the conductive tracks (107). The locking clip makes it possible to guarantee a secure electrical connection.

1. An arrangement for mounting and fixing a rearview camera to a structure element of a body of a motor vehicle, the arrangement being of the type in which the rearview camera is arranged at a rear of the motor vehicle and an optical axis of the rearview camera extends substantially longitudinally towards the rear of the motor vehicle;
the rearview camera being arranged inside a housing that is hermetically-sealed, and that is provided with a view window situated on the optical axis of the rearview camera;
said arrangement being characterized in that the window comprises an opening in the housing that is provided on the optical axis of the rearview camera and that is closed off by a transverse vertical pane made of a transparent material.

2. The arrangement according to claim 1, characterized in that the housing comprises a frame for supporting the transverse vertical pane which defines a rear transverse vertical wall, and in that the transverse vertical pane is pressed longitudinally towards the rear against a front transverse vertical face of the frame.

3. The arrangement according to claim 2, characterized in that the frame carries resilient elements which are in contact with a front transverse vertical face of the transverse vertical pane, for holding the transverse vertical pane pressed against a front face of the frame.

4. The arrangement according to claim 2, characterized in that a top face of a bottom transverse segment of the frame slopes downwards, from the bottom edge of the transverse vertical pane.

5. The arrangement according to claim 2, characterized in that the housing carries spray means for spraying cleaning liquid for cleaning an outside transverse vertical face of the transverse vertical pane.

6. The arrangement according to claim 5, characterized in that the spray means are formed integrally with the housing.

7. The arrangement according to claim 6, characterized in that the spray means comprise a nozzle that is fixed to a top horizontal wall ofthe housing.

8. The arrangement according to claim 3, characterized in that an inside vertical transverse face of the transverse vertical pane is covered with a layer of heater material suitable for generating heat.

9. The arrangement according to claim 8, characterized in that the resilient elements are made of an electrically conductive material so as to connect the heater material electrically to an electrical current source.

10. The arrangement according to claim 9, further comprising strips of conductive material that extend longitudinally inside the housing for electrically connecting the resilient elements to a current source.

11. The arrangement according to claim 10, characterized in that each of the resilient elements constitutes a rear end segment of a respective one of the strips of conductive material.

12. The arrangement according to claim 10, characterized in that the resilient elements are separate elements mounted on the rear ends of the strips of conductive material.

13. The arrangement according to claim 12, characterized in that each of the resilient elements is provided with a presser finger for pressing against the front face of the transverse vertical pane, which finger is suitable for sliding inside a tubular element, and is held resiliently in abutment against the front face of the transverse vertical pane.

14. The arrangement according to claim 10, characterized in that a front longitudinal end of each of the strips of conductive material extends inside a socket that extends upwards relative to a top wall of the housing, and that is open at its rear end for receiving a complementary connector.

15. The arrangement according to claim 1, characterized in that the housing is provided with a frame for supporting the transverse vertical pane, which frame is overmolded around a peripheral edge of the transverse vertical pane.

16. The arrangement according to claim 8, characterized in that the housing is provided with a frame for supporting the transverse vertical pane, which frame is overmolded around a peripheral edge of the transverse vertical pane, and characterized in that the frame and the transverse vertical pane are fixed to the housing by fixing means which are suitable for electrically connecting the layer of heater material to a current source.

17. The arrangement according to claim 16, characterized in that the fixing means comprise at least one clip arranged at one edge of the transverse vertical pane, and a longitudinal fixing catch that extends longitudinally forwards from the clip and that is suitable for being received in a complementary recess in the housing.

18. The arrangement according to claim 17, characterized in that the clip is provided with at least one contact finger for establishing contact with the layer of heater material.

19. The arrangement according to claim 16, characterized in that the fixing means are made in one piece by cutting out and folding a strip of electrically conductive material.

20. The arrangement according to claim 18, characterized in that the clip is provided with means for vertically positioning it relative to the transverse vertical pane.

21. The arrangement according to claim 16, characterized in that the fixing means are symmetrical about a horizontal midplane.

22. The arrangement according to claim 17, characterized in that the frame is overmolded around the clip of each fixing means.

23. The arrangement according to claim 1, further comprising a structural vehicle-body element having a rear vertical wall and a bottom horizontal wall which extends longitudinally forwards from a bottom edge of the rear vertical wall, and of the type in which a body of the housing passes through a complementary orifice in the bottom horizontal wall at least in part, said arrangement being characterized in that it is provided with means for deflecting water flowing over the rear wall, substantially above the rearview camera.

24. The arrangement according to claim 23, characterized in that the arrangement is provided with a tongue that extends vertically downwards from the bottom wall, behind the rearview camera, and that has a free bottom end edge that is arched so as to at least partially re-direct the water flowing over the rear wall.

25. The arrangement according to claim 24, characterized in that the bottom edge of the tongue is curved back towards the rear to form an arched lip.

26. The arrangement according to claim 23, characterized in that the rear vertical wall is provided with a projection that projects towards the rear.

27. The arrangement according to claim 1, characterized in that the housing is made of a transparent material, and in that each wall of the housing other than the rear vertical transverse wall is covered with a layer of an opaque material.

28. The arrangement according to claim 1, characterized in that the transverse vertical pane is in the form of a disk that is coaxial with the optical axis of the rearview camera, and in that a peripheral edge of the transverse vertical pane is provided with a thread that co-operates with a complementary thread in the frame so as to close the opening in the housing in waterproof manner and in removable manner.

29. The arrangement according to claim 8, further comprising:
at least one resilient electrical connection means; and
conductive tracks designed for electrically powering the layer of heater material suitable for generating heat;
the resilient electrical connection means being placed such as to generate electrical contact between said layer and said tracks.

30. The arrangement according to claim 29, characterized in that one resilient connection means extends over a first side of the rear face of the transverse vertical pane and another resilient connection means extends over a second side of the face opposite from the first face.

31. The arrangement according to claim 29, characterized in that the arrangement is provided with sealing means whose rear portion is overmolded around a peripheral edge of the resilient connection means and extends over a periphery of the rear face of the transverse vertical pane.

32. The arrangement according to claim 31, characterized in that the sealing means are in the form of a non-conductive elastomer.

33. The arrangement according to claim 31, characterized in that the sealing means further include a front portion connected to the rear portion via at least one bridge, the bridge being designed to be folded so that the rear portion and the front portion are placed respectively against the rear transverse face and against the front transverse face of the transverse vertical pane.

34. The arrangement according to claim 29, characterized in that the arrangement is provided with a thermal protection component for regulating the temperature of the layer.

35. The arrangement according to claim 34, characterized in that the thermal protection component is electrically coupled between the resilient connection means and the conductive tracks.

36. The arrangement according to claim 29, characterized in that the resilient connection means are filled with electrically conductive particles.

37. The arrangement according to claim 29, characterized in that the arrangement is provided with a locking clip suitable for compressing the resilient connection means between the transverse vertical pane and the conductive tracks.
